(19) United States
(12) Patent Application Publication
(10) Pub. No.: US 2015/0095264 A1
(43) Pub. Date: Apr. 2, 2015

(54) Financial Index

(71) Applicant: Robert H. Williams, St. Neots (GB)

(72) Inventor: Robert H. Williams, St. Neots (GB)

(21) Appl. No.: 14/504,744

(22) Filed: Oct. 2, 2014

Related U.S. Application Data
(60) Provisional application No. 61/885,645, filed on Oct. 2, 2013.

(51) Int. Cl. G06Q 40/06

(52) U.S. Cl. CPC G06Q 40/06
USPC 705/36 R

(57) ABSTRACT

The present invention relates to a financial index, a system and method for structuring a financial index, a system and method for operating a financial index, and a system and method for structuring an investment portfolio.

### CROSS REFERENCE TO RELATED APPLICATION

This application is based upon and claims priority of provisional application No. 61/885,645, filed Oct. 2, 2013, which is incorporated herein by reference in its entirety.

### FIELD OF THE INVENTION

The invention relates to construction and management of an index based on the performance of a portfolio of investment strategies. More specifically, the invention relates to methods and computer programmes for selecting and weighting investment strategies and related benchmarks in order to construct the investment portfolio.

### BACKGROUND OF THE INVENTION

Investors have historically made investments in equities (stock of companies, domiciled both domestically and internationally) and fixed income securities (government and corporate bonds). Today these investments are generally made in investment companies. As stated by the US Securities and Exchange Commission:

An investment company invests the money it receives from investors on a collective basis, and each investor shares in the profits and losses in proportion to the investor's interest in the investment company. The performance of the investment company will be based on (but it won't be identical to) the performance of the securities and other assets that the investment company owns.

The federal securities laws categorize investment companies into three basic types:

Mutual funds (legally known as open-end companies);

Closed-end funds (legally known as closed-end companies);

UITs (legally known as unit investment trusts).

Collectively these may be described as investment vehicles. The vehicles are managed by an investment manager that can apply various investment strategies to assist in identifying which securities and assets to invest with. The asset management industry that is responsible for managing these investment vehicles today manages some $27 trillion, according to recent reports [ICI].

The investment strategies pursued by the investment managers can be broadly categorized into two main groupings: passive and active management. As described by the US Securities and Exchange Commission: “passively managed mutual funds, known as index funds . . . try to equal, not beat, the returns of a major index, such as the S&P 500. Unlike actively managed mutual funds, which pick and choose investments based upon the research of the mutual fund managers, an index fund typically tracks the holdings of a chosen index through computer programmed buying and selling.”

At their most basic, a strategy of passive management might be described as one that looks to equal the performance of the relevant benchmark, while a strategy of active management would look to produce returns in excess of the benchmark. The CFA Institute describes a benchmark as follows: “a benchmark is a collection of securities or risk factors and associated weights that represents the persistent and prominent investment characteristics of an asset category or manager's investment process.” Examples of typical benchmarks include the S&P 500® index, which is comprised of the equities of US companies, weighted by their market capitalization; and the Barclays Capital Aggregate Bond Index, which is comprised of investment grade bonds traded in the US, weighted by their market capitalization.

Industry bodies representing the asset management industry have estimated that out of total assets under management, some 70-80% is invested in active management and 20-30% in passive management strategies [IMA, ICI]. The clear preference for active management strategies may logically be attributed to investors believing in the ability of their chosen investment manager to outperform the relevant benchmark.

Within the broad grouping of active management strategies, a variety of investment strategies can be utilized to identify those securities and assets which the investment manager believes will perform better than other securities within that market. For example an investment manager might focus on the stock of companies that they believe will grow earnings substantially in the near future (‘growth stocks’), or bonds issued by companies that they believe will be upgraded into a higher category of rating by a nationally recognized statistical rating organization (“rising stars”). A variety of methods can be used to select these securities. Two generally recognized categories of method are quantitative research and qualitative (or fundamental) research. Quantitative research can be defined as: “A method of appraisal of the worth of an asset or investment based on economic, econometric, mathematical, and statistical methods or models . . . ”. Qualitative research can be defined as: “Judgemental analysis of the worth of an asset or investment which cannot be readily quantified . . . ” [Handbook of International Financial Terms]

The large majority of these actively managed investment strategies share a common feature however—they are based solely on purchasing and owning the securities and assets for a period of time. This can also be described as going “long” of those securities and assets. A long position benefits from any price increase in the underlying asset. This term can also apply to financial derivatives, where for example the US Commodity Futures Trading Commission provides the following definition of a long position: “(1) One who has bought a futures contract to establish a market position; (2) a market position that obligates the holder to take delivery; (3) one who owns an inventory of commodities.”[CFTC Glossary]

The majority of investors are therefore invested in actively managed, long-only investment vehicles. A variety of investment strategies are used to identify a portfolio of securities and assets that the investment manager believes will out-perform an identified benchmark. The investment managers operate within guidelines and limits, i.e. a pre-agreed investment mandate, that prevents them from deviating too much from benchmarks and from investor expectations. This sensible approach ensures that investors know what to expect from their investments, and from their investment managers.

However, the arrangements discussed to this point also result in investors accepting significant market risk. Most notably, because investors are positioned long of the market, then they are exposed to significant falls in market value. For example many markets experienced significant falls in value during the economic crisis that began in 2007/2008. The S&P 500® index, which measures performance of large capitalization US equities, declined by −37% during the calendar year of 2008. One of the worst years for fixed income investors occurred in 1994, when the Barclays Capital Aggregate Bond Index, which measures performance of investment grade bonds traded in the US, declined by −3%. On these occasions the majority of investors are fully exposed to these declines in the value of the securities and assets held in their portfolios.

Moreover there are recognized “cycles” of market value, largely reflecting cycles of activity in the domestic and global economy—this is commonly referred to as the business cycle. Indeed the National Bureau of Economic Research (NBER) has a Business Cycle Dating Committee that officially determines the dates of turning points in the US economy. The NBER provides the following description of a business cycle: “A recession is a period between a peak and a trough, and an expansion is a period between a trough and a peak. During a recession, a significant decline in economic activity spreads across the economy and can last from a few months to more than a year. Similarly, during an expansion, economic activity rises substantially, spreads across the economy, and usually lasts for several years.” These cyclical movements in the real economy will generally influence financial markets; for example the stock market is often characterized as a leading indicator of the business cycle, and might therefore decline as investors sell their stocks on anticipation of an impending recession. In this manner investors may be exposed to recurring bouts of potentially negative performance in their portfolios.

The majority of investors, who use actively managed, long-only investment vehicles, are also exposed to other forms of market risk. One such risk is the volatility of their investments. Due to the effects of compounding, a highly volatile investment will generally realize an eventual return that is lower than would be the case for an investment with lower volatility. Investors with greater degrees of personal risk aversion may also find a number of traditional investments to be unsuitable as a result of their volatility. This form of risk could be broadly considered as a measure of the probability of loss that an investor must accept. A common statistical measure of this probability is the standard deviation of returns of an investment.

This measure is highly dependent on the observation period and timescale of measurement, but for equities has historically been roughly 18% and for a broad category of investment grade bonds it has been near 6%.

Investors have thus increasingly been looking for investment strategies that can help mitigate some of the risks of these actively managed, long-only investment vehicles. The broad category of strategies termed alternatives, and specifically hedge funds, are increasingly being used to meet this requirement.

The history of hedge funds is generally agreed to commence in 1952 with Alfred Winslow Jones. As described on www.wikipedia.org: “Jones married two speculative tools to create what he considered a conservative investment scheme. He used leverage to buy more shares, and used short selling to avoid market risk. He bought as many stocks as he sold, so market-wide moves up or down would be a wash on the total value of such a portfolio. The crucial question, then, would not be the direction of the market but whether the manager had picked the right stocks to buy and sell.” Short-selling is an investment method designed to profit from falls in the price of the underlying security. The US Commodity Futures Trading Commission provides the following definition: “Selling a futures contract or other instrument with the idea of delivering on it or offsetting it at a later date.”

This description of Jones' strategy gets to the heart of the key, original idea behind a hedge fund—that is to take risk on idiosyncratic investments as chosen by a skilled investment manager, while removing the general or systematic risk of the market itself. This idea is also present in the academic work of Harry Markowitz, William Sharpe, and Merton Miller who jointly received the Nobel Memorial Prize in Economics for work on topics in this area; specifically this includes the Capital Asset Pricing Model (CAPM), which addresses the idea that an investment into a risky asset will be exposed to both asset specific (idiosyncratic) risk and general market (systematic) risk.

More recently, hedge funds have developed and grown hugely. There are a large number of different investment strategies pursued, and various categories have been created to organize them; the widely-followed HFR indices have some 33 classifications of hedge funds for example and the overall hedge fund industry has some $2.3 trillion in assets under management (HFR). These vehicles and strategies were originally used by individual high net worth investors and family offices, and then increasingly by institutional investors. Some types of institutional investors have been identified as investing up to 20% of assets into hedge funds, though insurance companies and pension funds typically allocate smaller proportions of between 2-10% of their portfolios (Preqin).

These hedged strategies are now increasingly being put into the reach of retail investors as well. One report demonstrates that alternatives funds have experienced 21% annual growth in their share of long-term retail fund assets under management, and now account for 7% of the total (McKinsey). The same report estimates that alternatives will account for 13% of long-term 1940 Act funds (i.e. mutual funds) in the US.

These figures illustrate that modern investors, at all levels, have a demand for investment vehicles that provide access to hedged investment strategies. They are looking for ways to avoid taking on excessive or unrewarded market risk in their portfolios, but still want to use professional investment managers to manage and diversify their investments.

However investors have also increasingly identified negative aspects of many existing alternative strategies and hedge fund vehicles. Common charges held against hedge funds are excessive fees, limited redemption rights, and a lack of transparency. Other complaints include limited regulation and oversight, non-independent pricing of assets and dependence on third-party financing. Many of these issues were brought into stark relief during the economic crisis that began in 2007/2008. Many hedge funds induced features that prevented investors from accessing or redeeming their assets held in the fund. A number of these funds were found to be holding highly illiquid instruments and assets that had not been previously disclosed and which had no verifiable market price. This often resulted in the formation of special purpose vehicles and ‘side pockets’ to hold these assets, many of which still remain unresolved today.

Some newer funds have become available in more ‘investor-friendly’ formats providing liquidity, regulatory oversight and transparency. However these have generally been limited versions of existing strategies, rather than new strategies. As such many of them remain hampered by high fees and have not provided the anticipated differences from traditional hedge funds. Furthermore the performance of these new ‘liquid alternatives’ has generally failed to meet expectations; a recent study estimated that “the average difference in return between private and liquid alternative product offerings is 0.98%, annualized.” [Cliffwater]

Individual, corporate and institutional investors are therefore increasingly demanding more of their investments. Stable returns, lower fees and increased transparency are being demanded from investment managers. However there is also still a requirement for investment strategies that can help mitigate some of the risks of traditional, actively managed, long-only investment vehicles. In combination these dynamics require a new form of alternative investment. A vital group of investors has demonstrated a long felt but unsolved need for a liquid, transparent, and cheaper version of a hedged investment strategy. The invention described here, meets that need.

### SUMMARY OF THE INVENTION

The invention describes a system and method for constructing, managing and utilizing a financial index whose value is based upon the performance of a portfolio consisting of selected investment strategy vehicle(s) and related benchmark instrument(s). The process described is intuitive and transparent as well as being relatively easy to implement in a real setting, rather than simply being a theoretical construct. As such, both the methodology and resulting index could be used as a new form of reference against which to judge the performance of the established mutual fund industry, as well as informing general investment decision making within the asset management industry. When applied in the form of financial products making reference to the index, this invention could also meet a long felt but unsolved need by investors for a liquid, transparent, and cheaper version of a hedged investment strategy.

An exemplary embodiment of the invention may include collecting and storing data describing key characteristics of a universe of investment strategies, being primarily, though not exclusively, mutual funds. A subset of selected investment strategies would then be identified from the total universe, being those which display desirous characteristics. For example such characteristics could include, though not being limited to: consistent historical performance in excess of the benchmark (for example, those strategies achieving a Sharpe ratio in excess of 0.5); long and undisturbed tenure of the portfolio management team responsible for managing the investment strategy on a day-to-day basis (for example, those strategies with an unchanged primary portfolio manager in the last three years); positive performance in excess of the benchmark over varying historical periods (for example, positive excess performance measured over discrete time periods of the last three months, six months, one year, three years and five years—with greater weighting placed on more recent outperformance compared to more dated outperformance); volatility of returns that is similar and comparable to the benchmark (for example, those strategies with a standard deviations between +/−5% of the benchmark when measured over discrete time periods of the last three months, six months, one year, three years and five years—with greater weighting placed on more recent volatility compared to more dated volatility); high placing within a distribution of the excess returns of a peer group of investment strategies that may all be compared to the same benchmark (for example, those strategies in the top quintile ranking of such a peer group distribution).

The benchmark for each investment strategy may be determined through a direct statement by the investment manager for each investment strategy, or it may be determined through a quantitative method (for example, performing a regression of the historical returns of the investment strategy against multiple market indices that are expected in combination to provide a significant proxy for performance of the investment strategy). One or more market instrument(s) can then be identified to represent that benchmark, being primarily, though not exclusively, exchange-traded funds (ETFs). Typically, the market instrument can be identified through a direct statement by the investment manager for each market instrument (for example, the SPDR® S&P 500® ETF, ticker SPY, is managed by State Street Global Advisors and has an objective that it “ . . . seeks to provide investment results that, before expenses, correspond generally to the price and yield performance of the S&P 500® Index.” [State Street Global Advisors website]. Where multiple market instruments are identified to represent a benchmark, a quantitative process may be undertaken to make a selection. This process could include, though not being limited to: ranking instruments by expense ratio (for example, selecting those instruments with the highest or lowest ranking); ranking instruments by liquidity (for example, selecting those instruments with the highest ranked assets under management and average daily traded volume); ranking instruments by their correlation with the identified benchmark (for example, selecting those instruments with the highest ranked correlation to the identified benchmark). Data describing key characteristics of the benchmark and market instrument may also be stored in the database (for example their name, domicile, ticker, fees and expenses, gross and net performance, portfolio holdings, historical distributions, yield and ratings).

The subset of selected investment strategies may be paired with a market instrument representing the identified benchmark. A portfolio would then be constructed, consisting of long positions in the selected investment strategy vehicle(s) and short positions in the benchmark instrument(s). Weightings for each component of the portfolio may be determined using a standard constrained mean-variance optimization process (for example, targeting a portfolio with a maximum of 50 underlying components, with maximum weighting of 10% and minimum weighting of 1%, and an overall goal of maximizing the portfolio Sharpe ratio).

The index value may be calculated by increasing/decreasing the index value in proportion with the performance of the portfolio, over discrete time periods that will typically be daily.

### BRIEF DESCRIPTION OF THE DRAWINGS

FIG. 1 shows a series of steps for structuring and operating the financial index.

FIG. 2 shows an illustration of creating the database containing details about the investment strategies and their benchmarks and representative market instruments, using a wide variety of input sources.

FIG. 3 shows a regression analysis to determine the benchmark of an investment strategy.

FIG. 4 graphs the performance of an investment strategy and its benchmark.

FIG. 5 graphs the cumulative, indexed performance of a simplified portfolio consisting of a long position in the investment strategy and a short position in the benchmark.

FIG. 6 shows an example of grouping investment strategies with similar characteristics

FIG. 7 shows an example of calculating excess returns for a portfolio of investment strategies and their respective benchmarks. The performance of the portfolio over this time period is then the weighted average of these returns.

FIG. 8 demonstrates how an investment could be split amongst the components of an example portfolio.

FIG. 9 shows a computer system for implementing the invention

### DETAILED DESCRIPTION

Various detailed embodiments of the invention are discussed below, though any person skilled in the relevant art can recognize that other components, configurations, instruments, asset classes and benchmarks may be used without parting from the spirit and scope of the invention, which may therefore be embodied in various forms. In addition each of the examples given in connection with the various embodiments of the invention are intended to be illustrative, and not restrictive. The figures may include simplified or exaggerated features to highlight specific details. These are not intended to be limiting, but instead serve as a basis for the claims.

An exemplary embodiment of the present invention entails creation of an index based on the performance of an investment portfolio, comprised of investment strategy vehicles and benchmark representative instruments. In this embodiment a system, method and computer program are disclosed for construction of the portfolio and index.

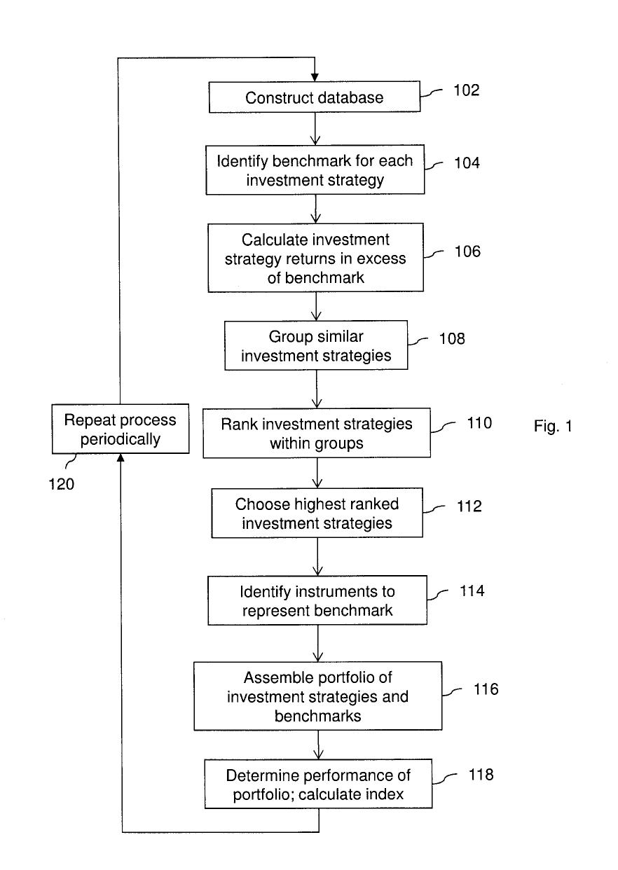

In one embodiment, illustrated in FIG. 1, a series of steps would be followed to create the portfolio and index:
1) Block 102: A database with performance and identifying features of investment strategies and investment vehicles is created. These strategies and vehicles will include mutual funds, closed-end companies, open-end companies, Exchange Traded Funds (ETFs), derivatives, managed accounts, hedge funds, REITs, MLPs, collective investment trusts, private pools and any form of regulated or unregulated investment strategy or vehicle. This database can be constructed with information from external sources (including Internet searches, websites, journals, newspapers and direct communication with asset management firms, banks and investment intermediaries), commercial sources, regulatory bodies and governmental organizations. Representative examples of the data collected will include the specific name of the investment manager and investment strategy; the domicile of the investment vehicle; the identifying ticker given to the vehicle and/or strategy; the fees and expenses associated with the investment strategy; the identified benchmark for the strategy; the identified instrument representing the benchmark; gross and net performance over a variety of timescales; portfolio holdings of the investment strategy; historical distributions and running yield of the investment strategy; and ratings of the investment strategy given by other financial service and information companies.
2) Block 104: A benchmark is established for each of the investment strategies or vehicles. The benchmark will often be stated directly by the investment manager or advisor. Where this is not stated directly, a proxy benchmark can be determined through regression of the strategy returns against recognized mainstream market indices.
3) Block 106: Measure the historical returns for each investment strategy in excess of the benchmark.
4) Block 108: The investment strategies are grouped together by similarities. For example groupings could consist of strategies with the same benchmark, strategies with similar return patterns, or strategies that use similar investment methods.
5) Block 110: Rank the investment strategies within individual groups. Groups will consist of comparable investment strategies (for example, those with similar stated targets of providing exposure to a market segment such as large capitalization US equities). The ranking process will use one or a combination of performance measures including upside versus downside excess return, Information ratio, Treynor ratio, Jensen ratio, Batting Average, Up Capture Ratio, Sharpe ratio, Appraisal ratio and Sortino ratio.
6) Block 112: Identify and select the highest ranked strategies.
7) Block 114: Identify market instruments that represent the benchmark for each chosen investment strategy. These instruments might include, though not being limited to, Exchange Traded Funds (ETFs), mutual funds, and derivatives (including but not limited to futures, swaps, options and total return swaps). The instruments will typically display a correlation greater than 0.75 with the benchmark, with market exposures that can be readily compared to the benchmark (for example, with both instrument and benchmark taking exposure to large capitalization US equities) and typically will be managed by an investment manager with a stated intention of providing performance closely matching that of the benchmark.
8) Block 116: Assemble a portfolio that is long of the investment strategies and short of the instruments representing the benchmark.
9) Block 118: Calculate an index representing the performance of the investment portfolio. Generically the index value can be calculated using the formula Iₜ₊₁=(1+Rₚₜ)*Iₜ where Rₚₜ is the return of the portfolio over time period t, Iₜ is the index value at the start of the time period, and Iₜ₊₁ is the index value at the end of the time period t.
10) Block 120: After a defined time period, typically daily, the process is repeated to take account of new performance information for the investment strategies and benchmarks.

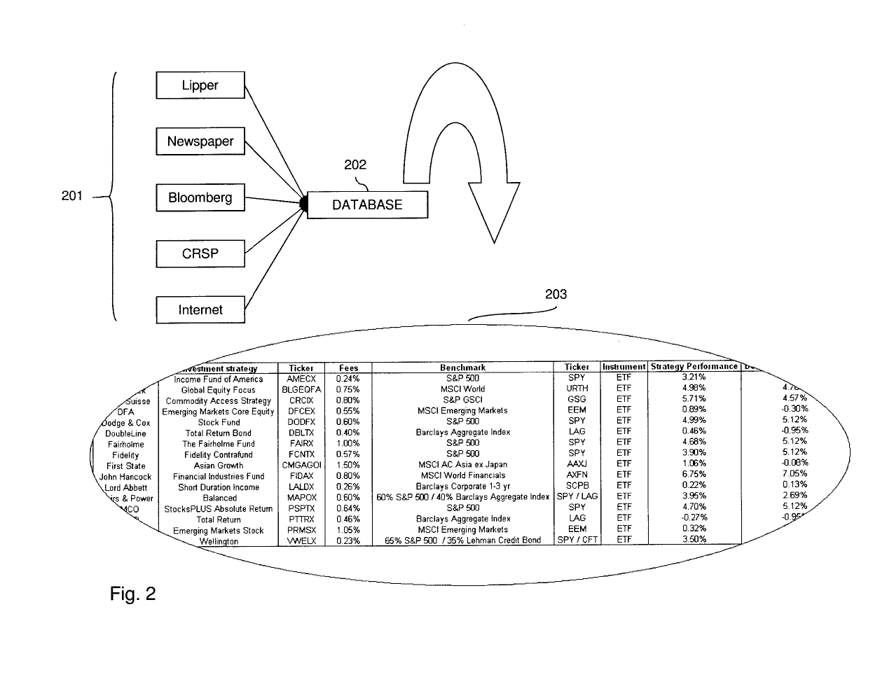

FIG. 2 shows a schematic of the method of creating the database as described previously in block 101. The various external sources of information shown as 201, provide data to be held in the database 202. An illustration of some of the actual data fields that might be held in the database, covering details of the investment strategies and their identified benchmarks (using the methods described in block 102 previously) is shown in block 203. These fields include the name of the investment manager, the name of the investment strategy, the ticker symbol allocated to the investment strategy, the fees associated with the investment strategy, the identified benchmark of the investment strategy, the ticker symbol allocated to the market instrument representing the benchmark, the security type of the market instrument, the performance of the investment strategy over a specified time period, and the performance of the market instrument representing the benchmark over the same specified time period. Fields included in the database are intended to identify and specify key characteristics of the investment strategies, which are relevant when comparing, grouping and ranking the investment strategies as part of the system and method disclosed here. For example, the field of the ticker symbol allocated to the market instrument representing the benchmark may be used to group together those investment strategies sharing the same associated ticker symbol (for example, a number of investment strategies that take exposure to large capitalization US equities may have the S&P 500® index as benchmark, and hence may have the associated ticker symbol SPY, representing the SPDR® S&P 500® ETF). The database 202 may be held in suitable types of computer-readable storage including, for example, random access memory, read only memory, magnetic storage, and optical storage. The data may be held in a single storage site, or multiple storage sites.

In some embodiments the investment strategies will be sourced from commercial databases including, but not limited to: Lipper; Morningstar; Bloomberg; Thomson Reuters; Fidelity; Zacks; Strategic Insight; Kiplinger; FE (Financial Express); and CRSP (Center for Research in Security Prices). In some embodiments the investment strategies will be sourced from Internet searches, direct contact with brokers and intermediaries, and the media.

In some embodiments the database will consist of fields including: the name of the investment manager that manages the investment strategy; the name of the investment strategy; the domicile of the investment vehicle; the identifying ticker given to the vehicle and/or strategy (such as an identifying ticker symbol on the Bloomberg or Reuters systems); the fees and expenses associated with the investment strategy; the identified benchmark for the strategy; the identified instrument representing the benchmark; gross and net performance over a variety of timescales including daily, monthly, annually and on rolling bases; portfolio holdings of the investment strategy; historical distributions and running yield of the investment strategy; and ratings of the investment strategy given by other financial service and information companies.

In some embodiments the database of investment strategies and investment vehicles will be created using a computer program. The program will determine suitable investment strategies and investment vehicles, based on a search process. The process will seek to identify, and remove from consideration, indexing strategies i.e. those strategies seeking to exactly replicate a stated benchmark and thus having minimal tracking error to that benchmark. (Tracking error, as defined by the NASDAQ exchange, is: “In an indexing strategy the standard deviation of the difference between the performance of the benchmark and the replicating portfolio”.) The process may also seek to identify investment strategies that are identical, missing data, closed to investors, or representing differing share classes of the same ultimate investment strategy.

In one embodiment the benchmark of the investment strategies is stated directly by the investment manager. For example, strategies focused on large capitalization US equities may be benchmarked against the S&P 500® index. Strategies focused on intermediate duration, investment grade bonds in the US may be benchmarked against the Barclays Intermediate Government/Credit index. Most investment strategies will explicitly or implicitly report performance against a benchmark that is deemed relevant. For example the largest mutual fund in the US (according to Morningstar, as of June 2013) was the PIMCO Total Return Fund; in this fund's investor reports a stated benchmark is the Barclays U.S. Aggregate Index.

In one embodiment the benchmark of the investment strategies is determined using an algorithm or computer program. This process will take performance data for each investment strategy and run statistical techniques to determine which market indices, in various weightings and combinations, best explain, or provide the best statistical fit, with the return pattern of each investment strategy. In another embodiment, the process will take performance data for the underlying securities held in the investment strategy portfolio and run statistical techniques to determine which market indices, in various weightings and combinations, best explain, or provide the best statistical fit, with the return pattern of the portfolio of underlying securities.

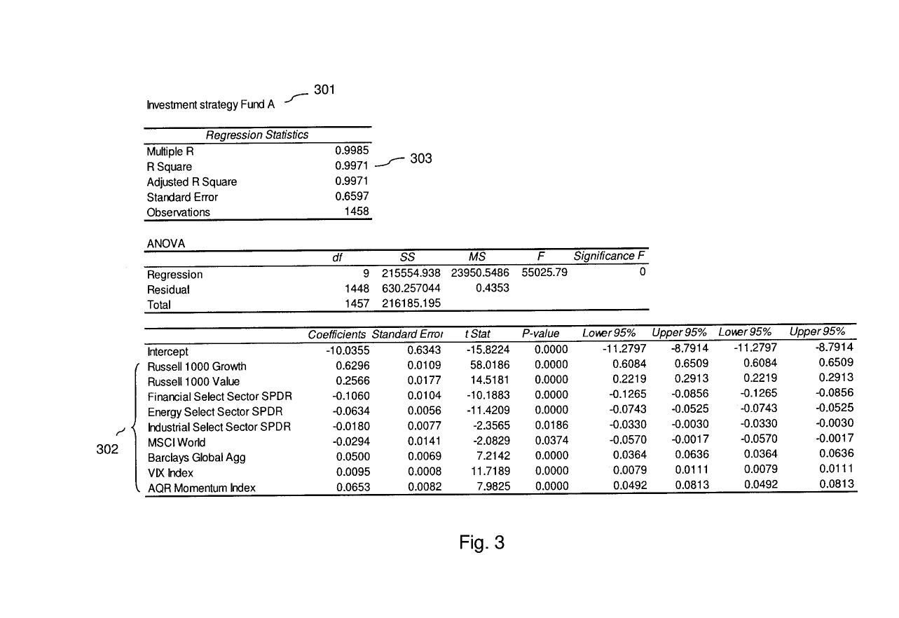

FIG. 3 demonstrates an example of a method for determining the benchmark for an investment strategy, when it has not been stated directly by the investment manager. The investment strategy 301 is a mutual fund that is widely available to investors, called Fidelity® Contrafund®. Published daily returns (over the period January 2008 to July 2013 inclusive) of this investment strategy are regressed against multiple market indices 302 that are expected in combination to provide a significant proxy for performance of the investment strategy. In this example the results of an ANOVA (Analysis of variance) calculation indicates a high coefficient of determination (or R-squared) 303 that suggests the model explains a large proportion of the variability of the investment strategy returns. This combination of market indices, weighted in accordance with the statistics of the model, would then comprise the overall benchmark for the investment strategy.

In one embodiment the investment strategies use equity securities. These securities will include, though not being limited to: ordinary shares; preference shares; depositary receipts; certificates; private equity; equity-linked instruments; rights; warrants; derivatives (including futures, forwards, swaps, options and total return swaps); and convertible bonds. The identified benchmark will then typically also be comprised of similar equity securities.

In one embodiment the investment strategies use fixed income securities. These securities will include, though not being limited to: government bills, notes and bonds; sovereign bonds; corporate paper, notes and bonds; strip coupons and residuals; zero coupon bonds; agency bonds; certificates of deposit; inflation indexed securities; municipal bonds; convertible bonds; variable interest rate notes; whole loans; bank debt; mortgages, asset-backed securities (including residential mortgage backed securities, commercial mortgage backed securities, collateralized debt obligations and collateralized loan obligations); securitized products and derivatives (including futures, forwards, swaps, options and total return swaps. For example credit default swaps, interest rate swaps and forward rate agreements). The identified benchmark will then typically also be comprised of similar fixed income securities.

In one embodiment the investment strategies use commodity related securities. These securities will include, though not being limited to: physical commodities; derivatives (including futures, forwards, swaps, options and total return swaps); exchange traded commodities; exchange traded funds; ordinary shares; preference shares; equity-linked instruments; warrants; structured products; inventory receipts; and any class of commodity accepted by recognized exchanges in settlement of a futures position. The identified benchmark will then typically also be comprised of similar commodity related securities.

In one embodiment the investment strategies use real estate or property related securities, typically being equity and fixed-income securities of companies principally engaged in or related to the real estate industry. These securities will include, though not being limited to: real estate investment trusts (REITs); Tenancy In Common investments (TICs); ordinary shares; preference shares; depositary receipts; certificates; private equity; equity-linked instruments; rights; warrants; derivatives (including futures, forwards, swaps, options and total return swaps); and convertible bonds. The identified benchmark will then typically also be comprised of similar real estate or property related securities.

In one embodiment the investment strategies use currency or currency related securities. These securities will include, though not being limited to: non-deliverable forwards; and derivatives (including futures, forwards, swaps, options and total return swaps). The identified benchmark will then typically also be comprised of similar currency or foreign exchange related securities.

In some embodiments the investment strategies will use a mix of asset classes including, but not limited to: equity securities; fixed income securities; commodity related securities; real estate or property related securities; and currency or currency related securities. The identified benchmark will then typically also be comprised of a similar mix of equity securities, fixed income securities, commodity related securities, real estate or property related securities, and currency or currency related securities.

In one embodiment the investment strategies all use quantitative methods to select a portfolio of securities to outperform the benchmark. For example, one such quantitative method could involve calculating the price-earnings ratio (calculated as market value per share divided by declared earnings per share) for each stock represented within the identified benchmark. The method would then involve sorting the stocks in order of the calculated ratio, with overweight positions taken in those stocks with the lowest ratios and underweight positions taken in those stocks with the highest ratios. In one embodiment the investment strategies all use qualitative or fundamental methods to select a portfolio of securities to outperform the benchmark. In other embodiments the investment strategies use a mix of quantitative and qualitative or fundamental methods to select a portfolio of securities to outperform the benchmark.

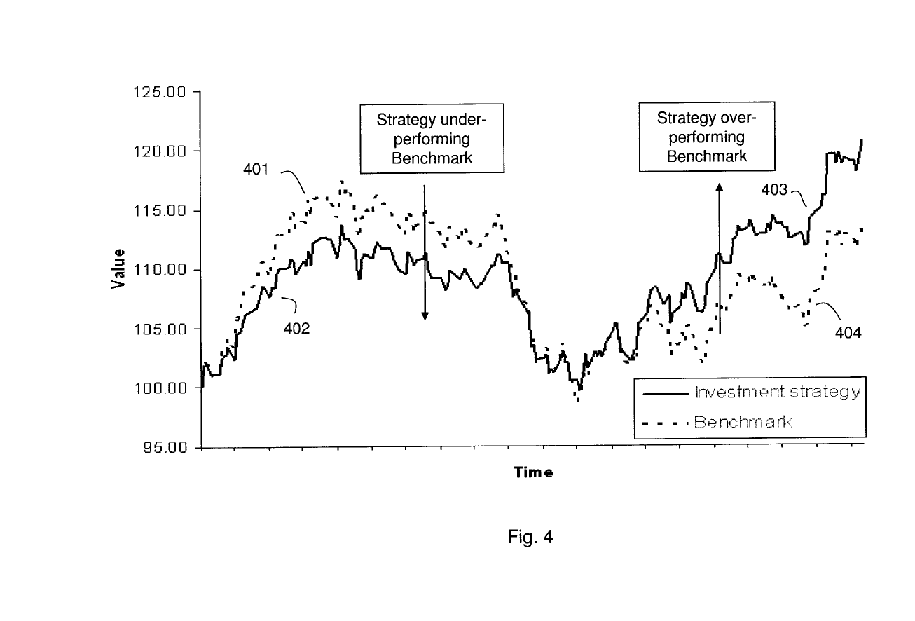

FIG. 4 is a graph showing performance of an investment strategy (in this example, a publicly available mutual fund called First State Asian Growth Fund) and the identified benchmark for that investment strategy (in this example, the MSCI AC Asia ex Japan Index). The vertical axis shows the indexed daily performance and the horizontal axis shows time passed. Performance was measured using published return data for the fund and index, between January and September 2012. At the beginning of the time period the benchmark 401 shows accumulated performance in excess of the investment strategy 402. However later in the time period the investment strategy 403 has now demonstrated returns in excess of the benchmark at 404.

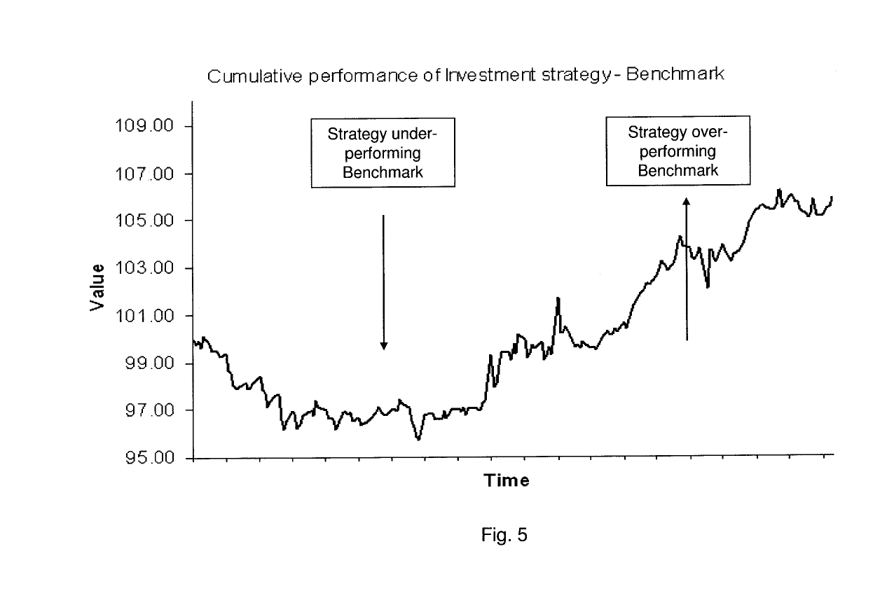

FIG. 5 is a graph plotting the cumulative, indexed performance of a simplified portfolio consisting of a long position in the vestment strategy graphed in FIG. 4 and a short position in the benchmark graphed in FIG. 4. At the beginning of the time period this portfolio has negative cumulative performance (the index value has dropped below its inception value of 100) due to the investment strategy having performance less than the benchmark, as highlighted at points 401 and 402 previously, in FIG. 4. However later in the time period the investment strategy is out-performing the benchmark (as highlighted at points 403 and 404 previously) and the portfolio has positive cumulative performance.

In one embodiment, a calculation is made of the return of an investment strategy in excess of the identified benchmark for that investment strategy. This excess return can be calculated as:

excess return=Rᵢₜ−R_{bt}

where
Rᵢₜ=the return of the investment strategy over time period t
R_{bt}=the return of the benchmark over time period t

In one embodiment, a calculation is made of the return of an investment strategy in excess of the market instrument representing the identified benchmark for that investment strategy. This excess return can be calculated as:

excess return=Rᵢₜ−Rₘₜ

where
Rᵢₜ=the return of the investment strategy over time period t
Rₘₜ=the return of the market instrument over time period t

The excess return may be measured on various absolute or rolling timescales, including daily, weekly, monthly, quarterly and annually. In other embodiments variations to the calculation of this performance measure may also be used. Variations could include, though not being limited to: upside versus downside excess return; Information ratio; Treynor ratio; Jensen ratio; Batting Average; Up Capture Ratio; Sharpe ratio; Appraisal ratio; and Sortino ratio.

In one embodiment an equal monetary value is invested in the investment strategy and the benchmark. In other embodiments unequal monetary values may be invested in the investment strategy and the benchmark. In some embodiments the values to be invested may be determined by a computer program or algorithm—for example, with weighting systematically increased at each rebalancing point toward those investment strategies that outperformed the benchmark during the most recent time periods, up to a specified maximum allocation to ensure diversification. In some embodiments the values to be invested may be determined through the discretionary judgement of one or more portfolio managers.

In one embodiment the investment strategies will be grouped with others that are determined to have similarities or shared characteristics. These characteristics could include, though not being limited to: benchmark; tracking error; geography; market; security type; investment methods employed; portfolio turnover; asset size; ratings of the investment strategy given by other financial service and information companies; and length of performance record. In one embodiment the categorization of strategies into groups will be manually achieved through the discretionary judgement of one or more people. In other embodiments the categorization of strategies into groups will be performed using a computer program or algorithm. A small selection of examples of groups that could be created include: “US large capitalization value equity (quantitative)”; “non market-capitalization weighted emerging market local currency debt”; “G-10 active currency”; “DJ-UBS commodity index with variable roll timing”; or “commercial property (including derivatives)”. A number of groups could be created and these may subsequently form the basis of sub-indices.

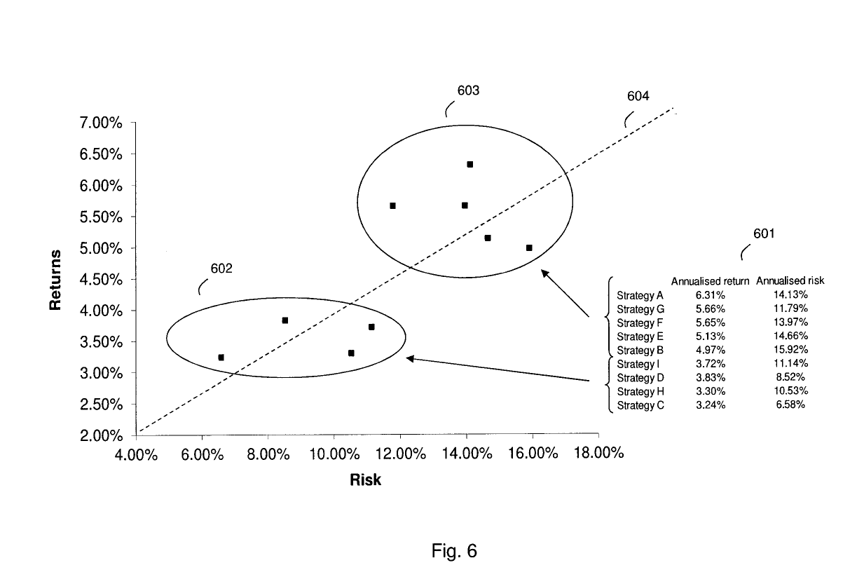

FIG. 6 is a graph illustrating an example of one embodiment of the present invention. A selection of hypothetical investment strategies has return and risk profiles as given 601. These are plotted on a graph and can be visually or mathematically determined to fall into two distinct groupings of lower risk-return profiles 602 and higher risk-return profiles 603. These profiles can be further compared to a line 604 that represents a desired and/or minimum level of risk-return profile. The level and gradient of this line (which is analogous to a Sharpe or Information ratio) could be statistically calculated (for example, as the mean profile of the group of investment strategies), or it could be determined through the subjective judgement of a portfolio manager. Those investment strategies lying above the line would therefore be displaying desirous characteristics and could then be selected or sub-divided further into other smaller groupings.

In one embodiment the investment strategies are ordered, within their respective groups, according to their calculated returns in excess of the identified benchmark. Statistical techniques may be employed to order and rank the excess returns data. Variations of this technique could include, though not being limited to: ordinal ranking, dense ranking, frequency distributions, sampling from probability distributions, ANOVA techniques, machine learning programmes, test statistics, and rank transform procedures.

In one embodiment the investment strategies are ordered according to the discretionary judgement of one or more people. In this embodiment analysts will use their skills and experience to subjectively assess attributes of the investment manager and the investment strategy. The assessment will include, though not being limited to: the perceived skill of the portfolio manager(s); the robustness, repeatability, uniqueness and other subjective qualities of the investment process(es); the availability of resources including a research and/or analysis team supporting the portfolio manager(s); the expertise and reputation of the investment management firm; and an assessment of the data, models and information available to the portfolio manager(s).

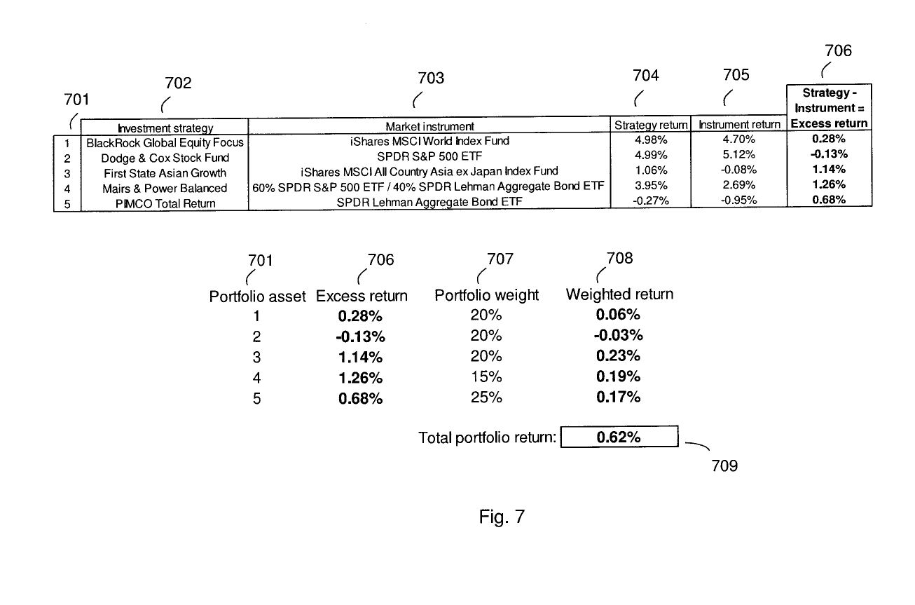

FIG. 7 provides an example of a hypothetical investment portfolio. For the purposes of this example used are publicly available investment strategies and benchmarks with widely published performance details and fully accessible investment vehicles and representative instruments. Returns are for the month of January 2013 and data was compiled from Bloomberg, Morningstar, BlackRock, Dodge & Cox, First State Investments, Mairs & Power, PIMCO Investments, iShares, and State Street Global Advisors.

The example portfolio is assembled with five component assets 701. Each asset is comprised of two positions: a long position in an investment strategy 702 and a short position in a benchmark representative market instrument 703. Over this time period, the return of the investment strategy vehicle 704 and the return of the benchmark representative instrument 705 can be used to calculate the excess return 706. The portfolio is assembled with a weighting 707 assigned to each asset. This provides a weighted return 708 for each asset which can be summed to produce the total portfolio return 709.

Asset number 1 in the example is thus comprised of two related positions. Firstly a long position in the BlackRock Global Equity Focus Fund. This is a mutual fund (ticker symbol BLGEQFA) that is widely available to investors. Secondly a short position in the iShares MSCI World ETF. This is an Exchange Traded Fund (ticker symbol URTH) that is widely available to investors. Asset number 2 is a long position in the Dodge & Cox Stock Fund mutual fund (DODFX) and a short position in the SPDR® S&P 500® ETF (SPY). Asset number 3 is a long position in the First State Asian Growth Fund mutual fund (CMGAGOI) and a short position in the iShares MSCI All Country Asia ex Japan ETF (AAXJ). Asset number 4 is a long position in the Mairs and Power Balanced Fund mutual fund (MAPDX) and a short position that is weighted 60% to the SPDR® S&P 500® ETF (SPY) and 40% to the SPDR® Barclays Aggregate Bond ETF (LAG). Asset number 5 is a long position in the PIMCO Total Return Fund mutual fund (PTTRX) and a short position in the SPDR® Barclays Aggregate Bond ETF (LAG).

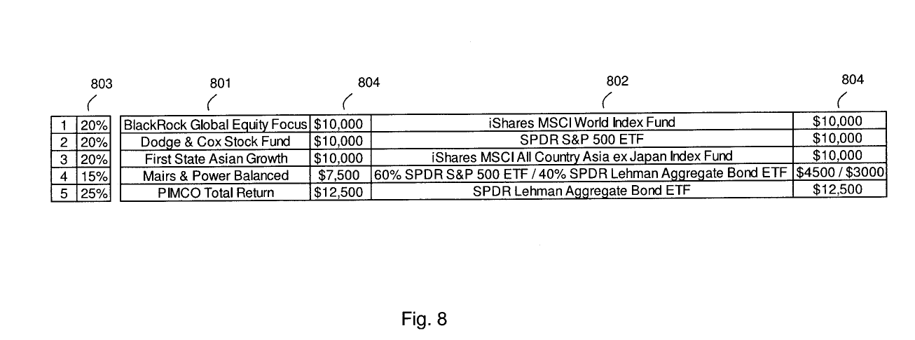

FIG. 8 shows the same hypothetical portfolio as was introduced in FIG. 7. The portfolio is constructed with equal monetary weighting across each investment strategy 801 and its paired benchmark representative market instrument 802. However the weighting 803 across the assets (pairs of strategies and benchmarks) is not equal. Using these weightings, an example $100,000 investment into the portfolio would therefore be allocated as illustrated 804.

In this example, January 2013 is the time period over which the index is calculated, using actual reported returns for each stated investment strategy vehicle and benchmark instrument during that month. The difference in performance between each long position and paired short position provides an excess return. The performance for the portfolio over this time period is then the weighted average of those excess returns. In this hypothetical example the portfolio returned +0.62% (box 709 in FIG. 7) for the month. The calculated index value based on this portfolio would thus increase by 0.62% over the previous index value.

Generically the index value can be calculated as:

Iₜ₊₁=(1+Rₚₜ)*Iₜ

where
Rₚₜ=the return of the portfolio over time period t
Iₜ=the index value at the start of the time period t
Iₜ₊₁=the index value at the end of the time period t

Completing the hypothetical example introduced in FIG. 6, we can use a starting index value of 100 on Dec. 31, 2012. After the month of January 2013 our portfolio has returned +0.62%. Our new index value for Jan. 31, 2013 will therefore be: (1+0.0062)*100=100.62.

In some embodiments the weighting of assets (defined here as a combination of a long position in an investment strategy vehicle and a short position in a benchmark representative instrument) in the reference portfolio may be equal or unequal. In some embodiments the weighting of assets may be determined by an optimization process that takes into account the historic performance and correlations of the assets.

The index may be rebalanced periodically. Rebalancing may be done daily, monthly, quarterly or annually in some embodiments. Other time periods may also be used for rebalancing.

In some embodiments, the index may be calculated in one or more currencies. For example, the value of the index may be calculated in US dollars, Canadian dollars, Euros, British pounds, Japanese yen or other currencies. In some embodiments, the index is calculated in local currency terms, where the portfolio is comprised of investment strategies that are each and all denominated in local currencies. In other embodiments, the index can be hedged to account for some or all of the currency risk arising from the investment strategies and/or benchmark instruments.

In some embodiments the index may be calculated as sub-indices, component parts or specified varieties. These different formats may be specified by a number of factors including, though not being limited to: geographic regions; investment styles; assets under management; currency denomination; length of track record; performance history; asset class; and corporate sector classification. Many combinations of the components and sub-indices are therefore possible.

In some embodiments a computer program or risk model may be used to replicate the portfolio holdings of one or more investment strategies. This process may be used to assemble a portfolio of securities and assets that closely resembles and mimics the performance of the investment strategy in question.

In some embodiments a notional or hypothetical amount may be invested in the investment strategies and benchmarks. In this instance the calculation of the index value can use as input the returns of the investment strategies and benchmarks as published directly by the investment managers and product providers, or from sources including commercial data providers, Internet searches, direct contact with brokers and intermediaries, and the media.

As those skilled in the art can recognise, the index described in this present invention could be applied in a variety of further uses. These could include, though not being limited to: development of financial products making reference to the index; investment decision making; asset management; and benchmarking of other investment strategies including mutual funds, ETFs and hedge funds.

In some embodiments, one or more computers or processors are used to calculate the index. In some embodiments the index can be output and stored in a computer memory, communicated over an electronic network such as the Internet, or sent to a display system such as a website, commercial financial system such as Bloomberg or Reuters Thomson, or a graphical user interface. In some embodiments, the index may be output to a system used for investment management of one or more vehicles including: mutual funds; closed-end companies; open-end companies; Exchange Traded Funds (ETFs); derivatives; managed accounts; hedge funds; REITs; MLPs; collective investment trusts; private pools and any form of regulated or unregulated investment strategy or vehicle.

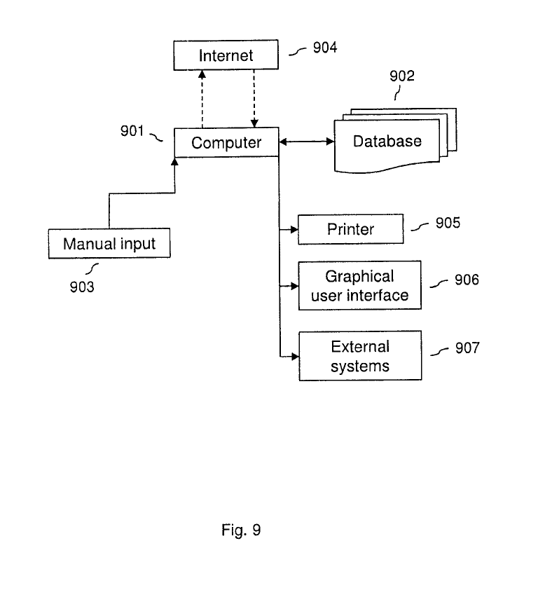

FIG. 9 shows, in block diagram format, a hardware implementation of the invention. A computer, block 901, is connected for two-way communications with the Internet, block 904. It also has a bi-directional connection to a series of databases, block 902. Computer 901 can receive instructions and information from a manual input, block 903. The computer 901 is also connected to provide output information to a printer, block 905, to a graphical user interface, block 906 and to various external systems, block 907, which have requested reports on the managed financial index.

1. A computer-implemented system and method of managing a financial index, comprising:
using public information sources to identify a universe of investment strategies (being primarily though not exclusively mutual funds), their stated or determined benchmarks, and market instruments representing those benchmarks (being primarily though not exclusively ETFs)
storing in a computer memory key descriptive data for the universe of investment strategies, benchmarks and representative market instruments;
calculating returns for each investment strategy in excess of its identified benchmark and representative market instrument;
programmatically grouping together investment strategies displaying similarities;
ordering and identifying the investment strategies with the best performance in each group;
determining a portfolio consisting of long positions in the selected investment strategy vehicle(s) and short positions in the benchmark instrument(s);
determining a weight for each component of the portfolio; and
programmatically calculating an index with direct reference to performance of the portfolio.

2. The method of claim 1, wherein the investment strategies comprise: mutual funds, closed-end companies, open-end companies, Exchange Traded Funds (ETFs), derivatives, separate accounts, hedge funds, fund of funds, REITs, MLPs, collective investment trusts, pooled trusts, private pools, limited partnerships or any form of regulated or unregulated investment vehicle.

3. The method of claim 1, wherein the investment strategies are screened to remove those strategies seeking to replicate the performance of the benchmark, and retain those strategies seeking to outperform the benchmark.

4. The method of claim 1, wherein the investment strategies invest in a subset of the available universe of traded financial instruments, comprising one or more of: equity securities and/or related securities and derivatives; fixed income securities and/or related securities and derivatives; real estate securities and/or related securities and derivatives; commodity securities and/or related securities and derivatives; and currency securities and/or related securities and derivatives.

5. The method of claim 1, wherein the benchmark is stated directly by the manager of the investment strategy.

6. The method of claim 1, wherein the benchmark is determined by performing a regression analysis with market indices.

7. The method of claim 1, wherein the excess return is calculated using a formula:
excess return=Rᵢₜ−R_{bt}
where
Rᵢₜ is the return of the investment strategy over time period t
R_{bt} is the return of the benchmark over time period t

8. The method claim 1, wherein a market instrument(s) is determined to represent each identified benchmark.

9. The method of claim 8, wherein the benchmark instrument(s) is determined using a computer algorithm, with the algorithm used to select instruments based on criteria comprising one or more of: cost; capital efficiency; tracking error; average traded volume; accessibility; counterparty risk; and regulatory requirements.

10. The method of claim 1, wherein the excess return is calculated using methods comprising one or more of: upside versus downside ratio; Information ratio; t-statistic; Treynor ratio; batting Average; up Capture Ratio; Sharpe ratio; Sortino ratio; Sterling ratio; appraisal ratio; and Calmar ratio.

11. The method of claim 1, wherein the investment strategies are grouped using a computer algorithm.

12. The method of claim 11, wherein the investment strategies are grouped according to shared characteristics, comprising one or more of: benchmark; tracking error; geography; market; security type; rating given by a nationally recognized statistical rating organization; investment methods employed; portfolio turnover; asset size; length of performance record; and excess return.

13. The method of claim 11, wherein the investment strategies are grouped according to statistical measures comprising one or more of: correlation; Spearman's rank correlation coefficient; Pearson product-moment correlation coefficient; and regression analysis.

14. The method of claim 1, wherein the investment strategies are grouped according to the discretionary judgement of an experienced individual, with the judgement to include an assessment of the style, methods and characteristics of each investment strategy and/or the investment manager of the investment strategy.

15. The method of claim 1, wherein investment strategies are selected within groups.

16. The method of claim 15, wherein investment strategies are selected using a computer algorithm, selecting strategies based on criteria comprising one or more of: return in excess of the identified benchmark; risk-adjusted return in excess of the identified benchmark; length of performance record; portfolio turnover; holding period of positions in the investment strategy portfolio; costs of the investment strategy (including all related fees and charges); correlation; Spearman's rank correlation coefficient; Pearson product-moment correlation coefficient; and regression analysis.

17. The method of claim 1, wherein a portfolio is assembled using a computer algorithm to optimize expected and historical characteristics of the portfolio, comprising one or more of: total return; standard deviation; Information ratio; t-statistic; Treynor ratio; batting Average; up Capture Ratio; Sharpe ratio; Sortino ratio; Sterling ratio; appraisal ratio; and Calmar ratio.

18. The method of claim 1, wherein a portfolio is assembled using the discretionary judgement of an experienced individual, with the judgement to include an assessment of the optimal portfolio composition with regard to one or more of: expected and historical return; expected and historical standard deviation; expected and historical correlations of portfolio components; and expected and historical correlation of the portfolio to other market indices.

19. The method of claim 1, wherein a range of weightings may be applied between the components of the portfolio, based on factors comprising one or more of: monetary values (both nominal and real); volatility; cost; expected and historical performance; expected and historical tracking error; and expected and historical correlations;

20. The method of claim 1, wherein the index is calculated from performance of the assembled portfolio using a range of nominal leverage values applied to the returns of the portfolio.
